(19) United States
(12) Patent Application Publication
(10) Pub. No.: US 2006/0282678 A1
(43) Pub. Date: Dec. 14, 2006

(54) System and method for using a secure storage device to provide login credentials to a remote service over a network

(75) Inventors: Asad Mahboob Ali, Austin, TX (US); Michael Andrew Montgomery, Austin, TX (US)

Correspondence Address: ANDERSON & JANSSON L.L.P., 9501 N. CAPITAL OF TX HWY #202, AUSTIN, TX, 78759, US

(73) Assignee: Axalto SA, Montrouge (FR)

(21) Appl. No.: 11/148,587

(22) Filed: Jun. 9, 2005

(51) Int. Cl. H04L 9/00

(52) U.S. Cl. 713/185

(57) ABSTRACT

Secure authentication to a remote server including transmitting login credentials from the secure storage device to the remote server. Transmitting from the secure storage device to the host computer a server list containing a list of servers available for secure authentication using the secure storage device. Using the list to establish a connection from the host to the remote server and to request the secure storage device to present the login credentials to the remote server. Transmitting from the secure storage device the login credentials and a login software module to the host computer. The login software module is automatically executed on the host computer to fill in the login page and to cause the transmission of the filled-in login page from the host computer to the remote server.

### TECHNICAL FIELD

The present invention relates generally to ensuring secure access to a remote server and more particularly to a system and method for secure authentication of a user by passing login credentials for a user from a secure storage device.

### BACKGROUND OF THE INVENTION

User authentication is one of the most vexing problems in the use of computerized devices. While computers have automated or even enabled many tasks, the use of computers and in particular the access of computerized services over networks has significantly increased risks. While security of personal and corporate data have been secured by the adoption of many security protocols and devices, e.g., encryption, secure protocols, and use of smart cards, these security mechanisms have seen attack in many different forms.

The use of user identification in conjunction with passwords or personal identification numbers (PIN) is one mechanism for protecting access to personal or private corporate data or services that require some form of authentication. Traditionally, the PIN is entered by a user in some type of text box and the PIN is transmitted to an authentication server.

However, passwords and PINs can be attacked and compromised even if these are transmitted over a secure channel in an encrypted form. For example, if an untrusted computer is used to enter an authorization phrase, software executing on that computer may be used to capture that PIN before the PIN has been passed to the encryption layer. Such software can be in the form of software that impersonates the service to which a user may seek access or in the form of keyboard loggers that capture keystrokes entered by users.

PINs and passwords can also be obtained by persons who simply look over the shoulder of a user entering such authorization phrases.

The Internet has become a very popular vehicle for carrying out many transactions that require user authentication. At the same time, the Internet has also made it possible to access private and sensitive information from many different locations. For example, with online banking it is possible for a banking customer to login to his bank account to view balances and make certain transactions from his home or office. However, while that is a relatively secure physical location on relatively trusted computers, other transactions may not be as safe. For example, online stockbrokerages make buying and selling securities possible while being logged in on a wireless network while having a latte in a café, and online auction services enable the sale and purchase of goods from public computers at a university. These are only examples; there is really no limit on the many different scenarios coupling online services where user authentication is extremely important with the use of computers that cannot be fully trusted either because of ownership, location, or by being exposed to malicious software that may have been deployed to illicitly obtain passwords.

The majority of servers that permit remote user logins employ some form of username/password to authenticate users before granting access. This is particularly true when logging into a remote web server via a web browser. Since good passwords are not easy to remember, there has always been a need to devise methods of storing and automatically “entering” the user's password without requiring the user to manually type it. To address this need there are numerous commercial software packages that allow a user to send login credentials to a remote web server without having to type the username and password in a web form. However, all these existing solutions suffer from one or more of the following drawbacks:
1. They require installation of a host application.
2. The solution is not portable; it is restricted to a single machine where the host application is installed.
3. Confidential data such as passwords are stored on the host PC, and is, therefore, vulnerable to attack.
4. They do not guard against any phishing or spoofing attacks that can send the user data to a fictitious server.

There are two broad categories of current solutions. The first category consists of data-on-host solutions. In these solutions there is no external token. The user data is stored in the host application. Examples of this are RoboForm, from Siber Systems, Inc., and Ghostsurf, from Tenebril, Inc.

The second category consists of data-on-external-token solutions that store data on a conventional smart card, but still require a host application to transfer this data to the remote server. An example is the Otanium Suite available with some laptops sold by Dell Computer Corporation.

FIG. 1 is a schematic illustration of the data-on-host class of solutions in which the user login credentials are kept on the host computer 101. A user uses a standard web browser B1 103 to connect to the login page of a remote merchant serverABC 105 over a network 104. Examples of web browser B1 103 include Mozilla Firefox, Safari from Apple Computer Corporation, and Microsoft Internet Explorer.

A specialized application program A1 107 monitors the communication data flowing between the browser B1 103 and the remote server 105. The application program A1 107 automatically fills in the username and password data in the login HTML form by reading this data from a data repository D1 109 on the host computer 101. The repository D1 109 can either be a file on the host computer 101 or can be kept inside the system Registry database of the host computer 101.

FIG. 2 is a schematic illustration of the class of solutions wherein the user login data D1 209 is not kept on the host computer 201 that the user is connecting from, but on an external hardware token 207; e.g. a conventional smart card.

As before, the web browser B1 103 is a standard web browser through which a user connects to the login page of a remote server serverABC 105. An application A1 213 monitors the communication data between the browser B1 103 and the serverABC 105 and inserts the username and password into login HTML form. The application A1 213 reads the login data D1 209 from the smart card 207. Because mainstream PC applications cannot communicate with conventional ISO 7816 based smart cards, a smart card specific middleware application M1 211 is required to read data from the smart card 207.

Recent advances in smart card research have made it possible to treat the smart card as a network peer. As a network peer, the smart card (a network smart card) can communicate securely with other computers on the network using standard mainstream network communication protocols like TCP/IP and SSL/TLS. Network smart cards and their use are described in greater detail in co-pending and co-assigned U.S. patent application Ser. No. 10/848,738, entitled, “SECURE NETWORKING USING A RESOURCE-CONSTRAINED DEVICE” of Hongqian Karen Lu, Michael Andrew Montgomery, Asad Mahboob Ali, the entire disclosure of which is incorporated herein by reference.

Network smart cards can be used to send a user's login credentials to remote servers. However, this approach, though extremely secure, requires the remote server to be modified so that it can accept login credentials from a smart card. Modifications to large established computerized services can be very costly and time consuming. Furthermore, if a user would prefer to have his passwords stored on a storage device to alleviate the need for remembering the passwords but the online service does not wish to make the required modification, the user would still be precluded from that option.

As discussed above, an alternative approach is to automatically fill form data in browsers from a smart card. However, that solution requires the installation of a host application and possibly some middleware.

From the foregoing it will be apparent that there is still a need for a way to provide login credentials from a trusted and secure storage device, e.g., a smart card, to a remote server in a manner that does not require modification of the software or hardware used by either the host computer or the remote server.

### SUMMARY OF THE INVENTION

In a preferred embodiment the invention provides a system and method for automatically providing login credentials to a remote server using a secure storage device without requiring any modifications to the remote server or requiring any special software on the host computer from which a user is attempting to connect to the remote server.

An embodiment for secure authentication to a remote server includes transmitting from the secure storage device to the host computer a server list containing a list of servers available for secure authentication using the secure storage device. The list is then used to establish a connection from the host to the remote server and to request the secure storage device to present the login credentials to the remote server.

In response to receiving the login request, the secure storage device transmits the login credentials and a login software module to the host computer. The login software module is automatically executed on the host computer to fill in the login page and to cause the transmission of the filled-in login page from the host computer to the remote server.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a schematic illustration of the data-on-host class of solutions to the problem of automatically providing login credentials to a remote server.

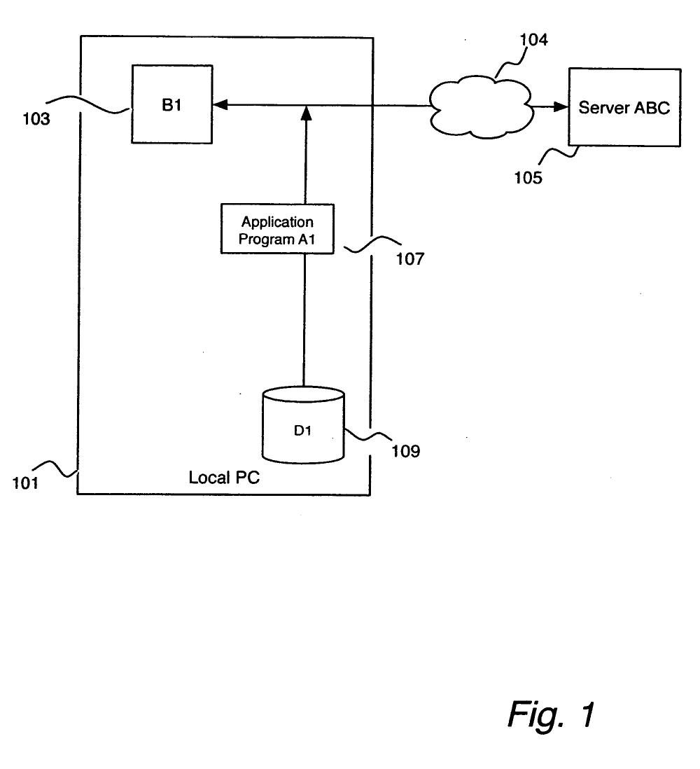

FIG. 2 is a schematic illustration of the class of solutions wherein the user login data is not kept on the host computer that the user is connecting from, but on an external hardware token; e.g. a conventional smart card.

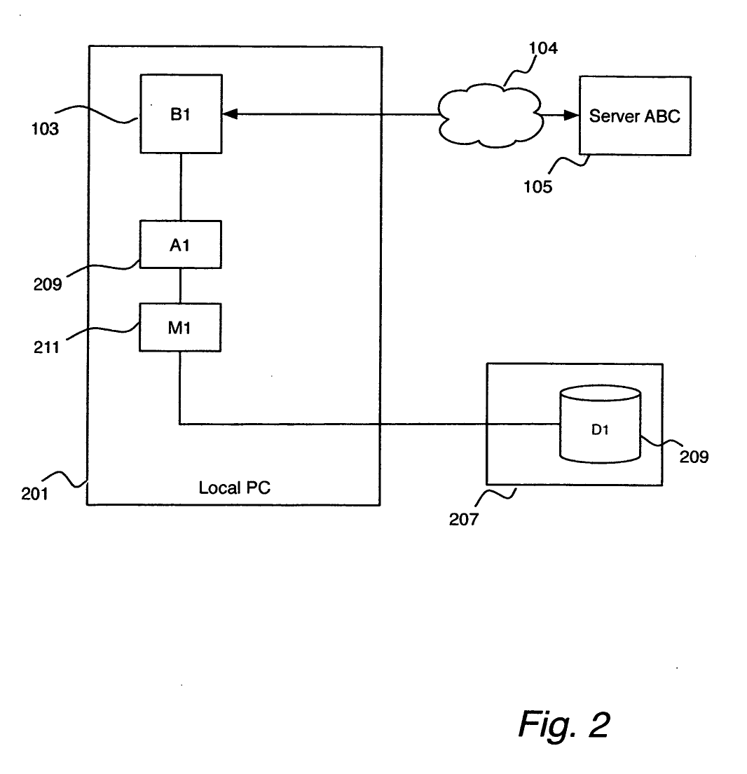

FIG. 3 is a schematic illustration of an example of a high-level view of a network in which login credentials are automatically provided to a remote server according to the system, apparatus, and method of the invention.

FIG. 4 is a timing sequence diagram illustrating the data flow in one embodiment of the invention and corresponding to the hardware architecture of FIG. 3.

FIG. 5 is a screen shot of an example services page displayed on a first web browser in conjunction with the execution of the timing sequence diagram of FIG. 4.

FIG. 6 is a screen shot of an example of a login page displayed in a second browser instance in conjunction with the execution of the timing sequence diagram of FIG. 4.

FIG. 7 is a block diagram illustrating one possible hardware architecture for the secure storage device according to the invention.

FIG. 8 is a block diagram illustrating several software modules of one embodiment of smart card web server according to the invention.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Introduction

As shown in the drawings for purposes of illustration, the invention is embodied in a novel system and method for providing user login credentials to a remote server using a secure storage device, e.g., a smart card, to store the login credentials and to provide the login credentials to the remote server without requiring modifications to the host system used by the user or to the remote server the user is seeking to access.

In one embodiment of the invention, a software module, e.g., a JavaScript, for providing login credentials and a standard web browser on the host computer are used to transfer login information from a network smart card (e.g., a network smart card as described in co-pending patent application Ser. No. 10/848,738) to a remote server wherein the remote server does not require any modification to accommodate the solution provided by the invention. Furthermore, no additional application software is required on the host. Furthermore, since the network smart card does not require any smart card specific middleware or reader drivers this approach provides an extremely portable way of carrying the login credentials of multiple existing commercial servers on the smart card and then logging into these servers. The servers do not have to be modified to allow this login.

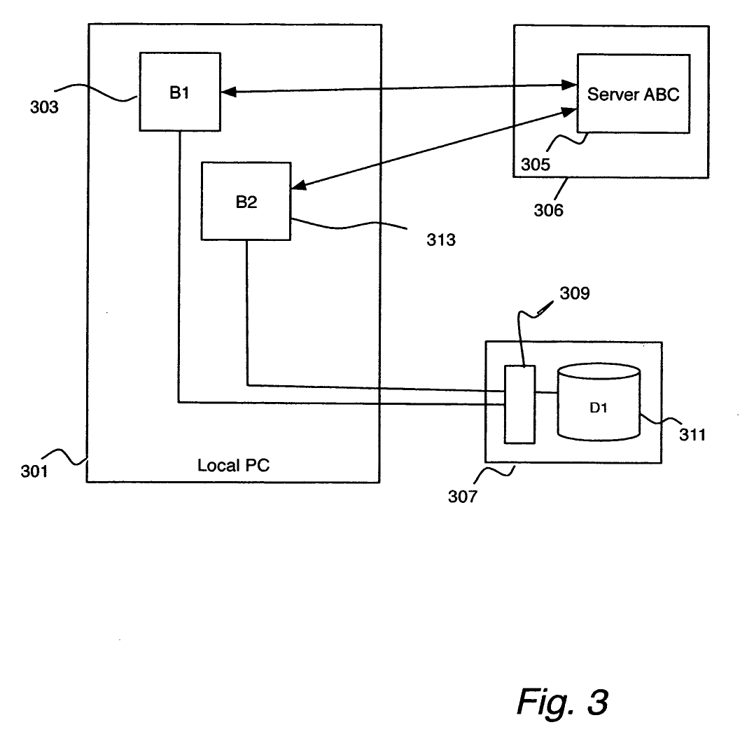

FIG. 3 is a schematic illustration of an example of a high-level view of a network in which automatic provision of login credentials are provided to a remote server according to the system, apparatus, and method of the invention. A user operating a host computer 301 uses a web browser B1 303 to connect to a remote server 305 operating on a remote server host 306 that is connected to the host computer 301 over a network, e.g., the Internet. The host computer 301 is also connected to a smart card 307.

The smart card 307 is a network smart card (NSC) having thereon a network smart card web server 309 and a store D1 311 for holding login credentials.

The user login credentials are passed from the smart card 307 to the remote server 305 using a second web browser B2 313. In alternative embodiments, web browsers B1 303 and B2 313 are different windows within the same web browser, are different flames within the same web browser window, two different web browser tabs (e.g., as provided in Mozilla Firefox), or even combined into the same web browser window and operating within the same frame.

In a preferred embodiment, the web browsers B1 303 and B2 313 are two distinct web browser windows. Accordingly, the examples that follow are described in the context of two web browser windows. However, that implementation must only be considered as an example and not as a restriction on the claims.

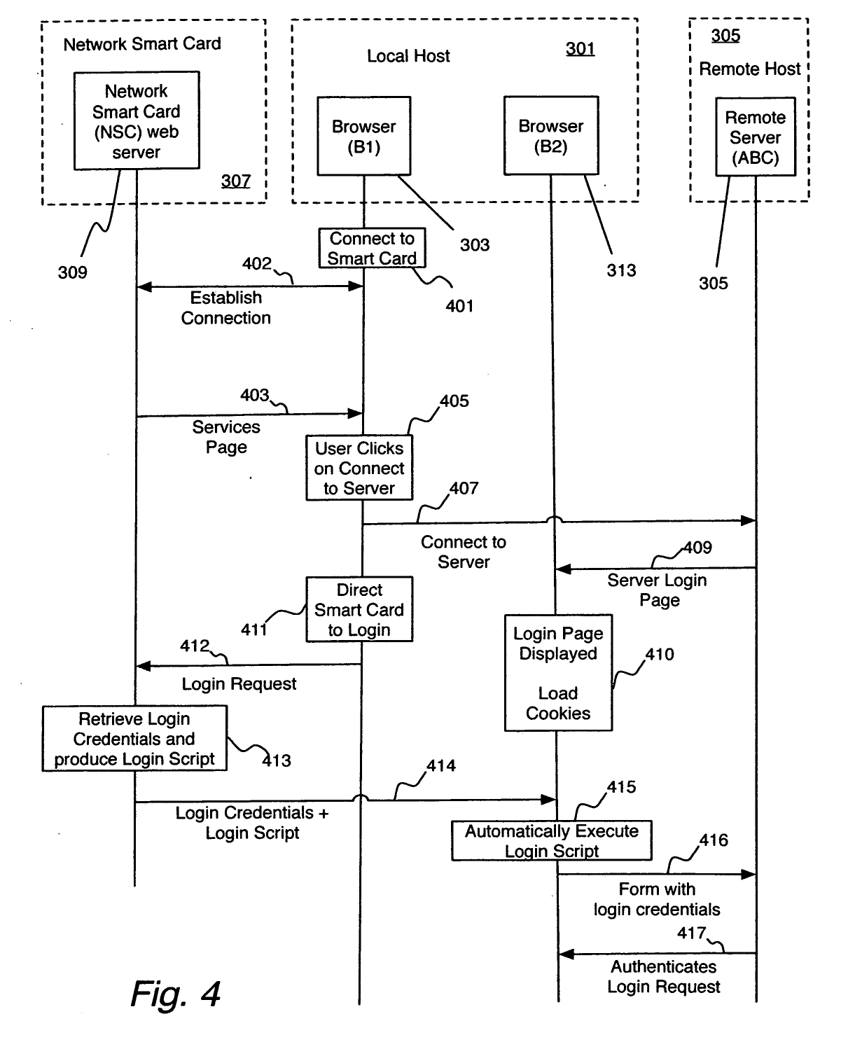

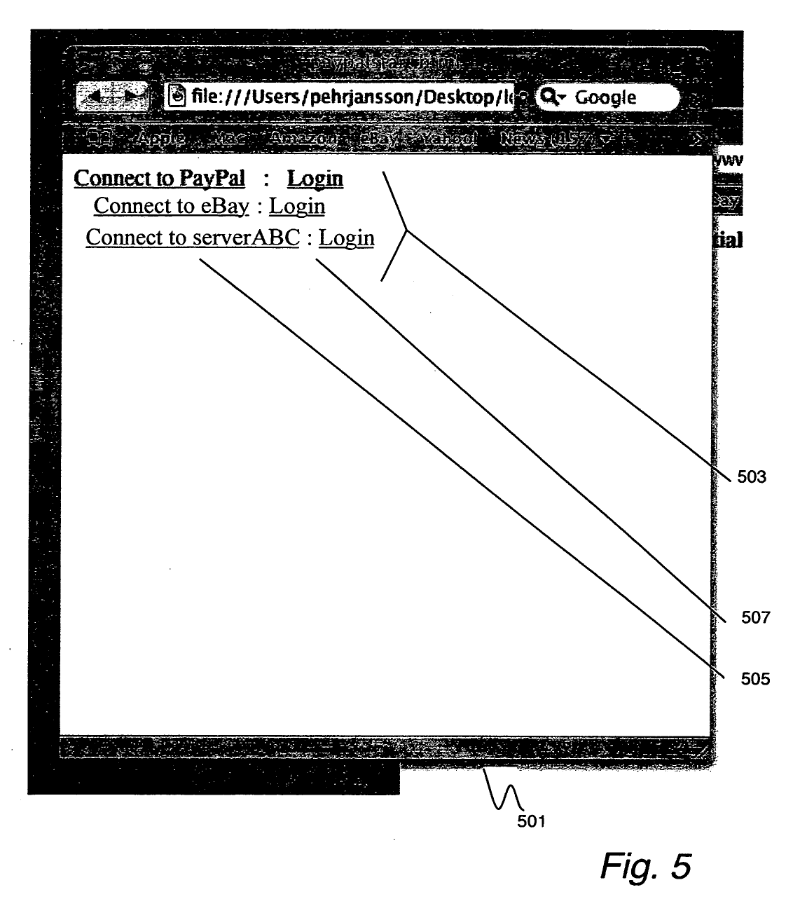

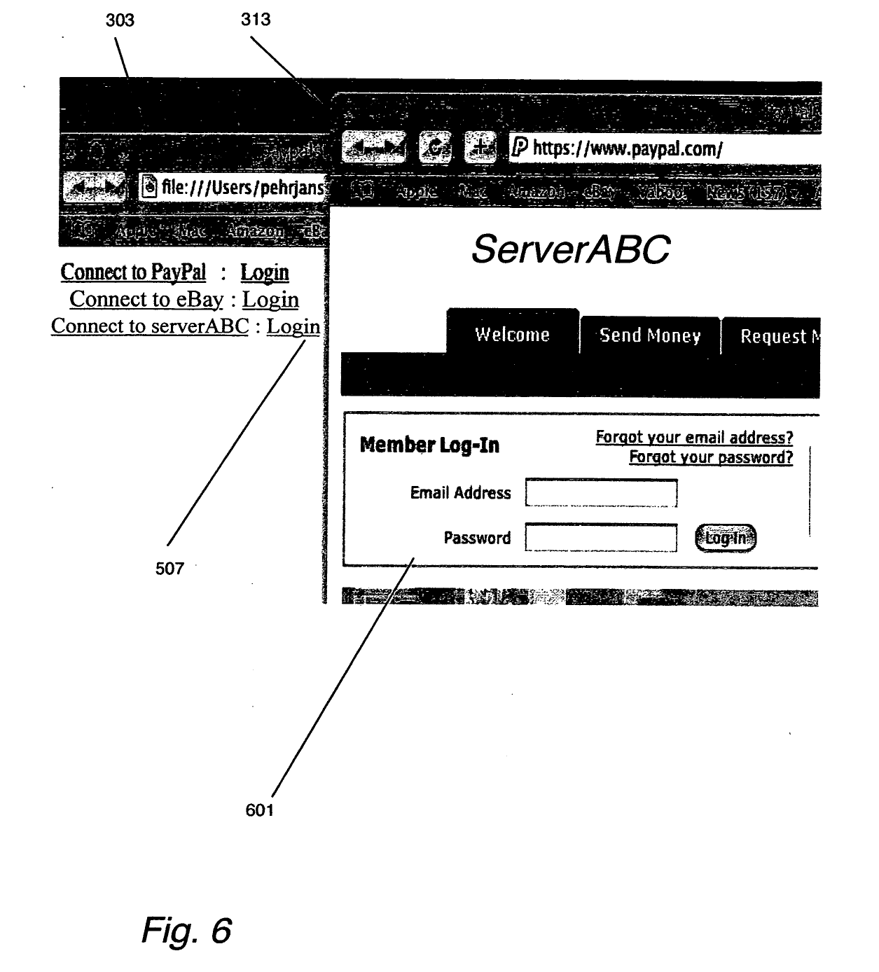

FIG. 4 is a timing sequence diagram illustrating the data flow in one embodiment of the invention and corresponding to the hardware architecture of FIG. 3. The brief description provided immediately herein below is expanded upon in greater detail further below.
1. The user opens a browser B1 303 and connects to the IP address of the NSC (Network Smart Card) 307, Step 401, through message traffic 402. The NSC web server 309 requests the user to log in to the smart card 307, typically by entering a PIN (Personal Identification Number). After entering the PIN the user is authenticated to use the card 307.
2. The NSC web server 309 sends a services page to browser B1 303, message 403. The Services page is a list of services the network smart card offers, e.g., one of the services is to use the network smart card to securely login to remote unmodified server. The services page is, for example, an HTML webpage that has the list of remote servers for which the card has login credentials. FIG. 5 is a screen shot of an example services page displayed on browser B1 303. Each server is represented by a pair of links; one connecting to the remote server, e.g., link 505, and the other back to the NSC, e.g., link 507. Note that the present invention is described in the context of automatic provision of login credentials to a remote server. Therefore, for the sake of clarity, in the examples provided herein, the services page does not show other services that are provided by the smart card.
3. The user clicks on one such server link, step 405, e.g., serverABC. A connection is made to the login URL of the server, message traffic 407.
4. The login page is downloaded from serverABC into a new browser window B2, message 409. The connect-to-services links, e.g., the link 505, contains direction to open the response in a new web browser window B2 313. By opening a new web browser window 313, the server can write any cookies that are necessary during the login process, step 410. The cookies are written to the host 301. Many online services use session specific cookies to provide additional security. In case these cookies are session specific, they are associated with the browser instance B2. FIG. 6 is a screen shot example of a login page 601 displayed in browser instance B2 313.
5. Instead of filling the login information in B2, the user directs the network smart card web server 309 to login to the remote server 305 by clicking on the login link in browser instance B1 303, e.g., link 507, step 411. This is the link corresponding to the server link picked in step 3. The user's click on the login link 507 sends a login request back to the NSC web server 309, message 412.
6. In response to receiving the login request message 412, the NSC web server 309 retrieves the appropriate login credentials from the store 311 and produces a login software module, step 413. The NSC web server 309 sends an HTML form template that matches the form used for login at serverABC 305 and a login software module, e.g., in one embodiment a small JavaScript code, message 414. The form data as well as the software module are loaded in browser instance B2 313. Browser instance B2 313 is the same browser that previously contained the login page 601 from serverABC. The form elements are all marked as “hidden” so the form elements do not show up in the browser window. Instead a message is displayed indicating that user login information is being sent to serverABC.
7. The login software module (e.g., JavaScript code) is automatically launched by the browser instance B2 313, step 415. The login software module uses login credentials data transmitted with it from the NSC web server 309 to fill the login form, and then causes the form to be submitted to the remote server 305, by invoking the submit( ) action on the form, step 415.
8. The browser instance B2 313, in response to the submit( ) action, transmits the form containing user login information to the URL on serverABC 305 that authenticates login requests, message 416.
Once serverABC authenticates the user, user is granted access to the remote server 305. A welcome screen is sent back to the browser instance B2 (313), message 417.

With the above-described message flow, a network smart card (NSC) 307 may be used to connect seamlessly to an unmodified remote server 305 and to provide the login credentials of a user to the remote server 305.

### DETAILS OF A PREFERRED EMBODIMENT

As described herein-above a preferred embodiment of the invention relies on a combination of an HTML form and JavaScript code to transfer user login credentials from a network smart card (NSC) to a remote server.

In a simple ideal case the user login credentials, e.g., user login name and password, may be sent to a remote web server using a simple HTML form template using a single web browser instance B1 301. The form template consists of three principal elements:
The URL to which the form is to be posted, e.g., https://www.serverABC.com/doLogin
The name of the input tag corresponding to the username, e.g., userID
The name of the input tag corresponding to the password, e.g. userPassword

Once these three elements are known, a form can be constructed as illustrated in Table 1:

TABLE 1
HTML Form template for sending user login data

```
<form action=“https://www.serverABC.com/doLogin”>
  <input name=“userID” value=“myUserID”>
  <input name=“userPassword”
  value=“myUserPassword”>
</form>
```

The actual values for the userID and userPassword fields can be stored on a secure hardware token 307, e.g., a Network Smart Card. These values are then read from the secure hardware token 307 and placed in the form template. The filled-in form is then submitted to the URL indicated in the action element. In theory these steps are all that is needed to login to the remote server 305 using a secure hardware token 307. However, in practice this approach seldom works.

The reason the simple ideal case described above does not work is the use of session cookies by many remote servers. A cookie is a packet of information sent by a server to a browser and then sent back by the browser each time the browser accesses that server. Servers store cookies on the local client machines for two reasons. The first is to identify users and keep track of their browser session at the server. The second reason is to prevent repeated automated login requests. Servers regard such requests as attempts by a potentially malicious user to break into existing accounts on the server. Therefore, servers reject login requests from browsers that fail to present adequate set of cookies.

The cookies are placed in the user's machine when the user connects to the login page of the server. The server can choose to put one or more cookies for each login session. The cookies can also be time stamped so they cannot be used after their time has expired. All this is done to make sure that it is an actual user who is trying to login, and not an automated script with malicious intentions.

A system and method according to the invention extends the simple ideal case scenario to make it possible to transfer login credentials from a secure storage token, e.g., a smart card, to remote servers when taking into account the constraints imposed by most online servers.

In one embodiment of the invention, a secure storage token interacts with a web browser to perform the login operation to a remote server as a process having two logical steps: 1. connect to a login page of the remote server and allow the remote server to write cookie data, 2. send user login credentials to the remote server from the same browser instance used in step 1. The two-step login process solves the disparity between the simple form submission scenario and the real world authentication environment wherein commercial web servers use an extensive set of session cookie logic. In the first step, in response to a user's request to connect to a remote server, the login page from the remote server is downloaded into a second web browser instance. The remote server is thus given the opportunity to write all authentication related cookies to the local host machine into that second web browser instance. After the cookies have been written, the second web browser instance can be used to load and send the completed HTML form template of Table 1 to the remote server. Because the second web browser instance is used, the remote server accepts the login credentials passed by the form and the user is granted access.

Returning now to FIG. 4, as a first step a connection is made to the network smart card web server 309, step 401 and message traffic 402. In response, the network smart card web server 309 sends a message 403 containing a web page of services to which a user may log in using the network smart card 307. The web page, e.g., the web page 501 as illustrated in FIG. 5, contains a list of remote servers for which the card has login credentials. In a preferred embodiment, each remote server is represented by a pair of links. An example HTML code for producing such a pair of links is illustrated below in Table II.

TABLE II
HTML Listing for generating a links to connect and login to a
remote server.

```
1  <HTML><body>
2  <A href=“https://www.serverABC.com” TARGET=B2>
    Connect to ServerABC</A>
3  &nbsp;
4  <A href =
    ”https://myNetworkSmartCard/serverABC.html”
    TARGET=B2> Login </A>
5  </body></HTML>
```

The link “https://www.serverABC.com” connects to the login page of the remote server serverABC 305. The link https://myNetworkSmartCard/serverABC.html connects to the corresponding page on the network smart card 307. Both links have browser B2 313 as their respective targets.

Next the user clicks on one such server link, e.g., the link 505 to login to serverABC 305, step 405. A connection is made to the login URL of the server, https://www.serverABC.com/login, step 407.

The login page is downloaded from serverABC, 305, into a new browser window B2, message 409. This allows the server to write any cookies that are necessary during the login process. The cookies are written to the host PC 301, step 410. In case these cookies are session specific cookies they are associated with the stance B2 313.

Instead of filling the login information in web browser B2 313, the user clicks on the login link (line 4, Table 2) in web browser instance B1 303, i.e., the login link 507. This is the link corresponding to the server link picked in step 405. This click sends a request (https://myNetworkSmartCard/serverAbc.html) back to the NSC web server, 309.

The response from the NSC web server 309 is displayed in the web browser B2 313, over-writing the login page 601 from the remote server serverABC 305. This response data, message 414, consists of an HTML form template that matches the form used for login at serverABC. An example of the HTML code is shown in Table 3.

TABLE 3
ServerAbc.html file generated by a smart card.

```
1  <HTML><BODY>
2  Secured by Axalto Network Smart Card :<br>
3  Your login credentials are being passed to
      serverABC, please wait ...
4  <FORM method=“post” name=“loginForm”
      action=“https://www.serverABC.com/doLogin”>
5  <INPUT type=“hidden” name=“userID” value=“”>
6  <INPUT type=“hidden” name=“userPassword”
      value=“”>
7  </FORM>
8  <IFRAME SRC=serverAbcLogin.html name=“autoLogin”
      ALIGN=bottom FRAMEBORDER=0>
9  </IFRAME>
10  </BODY></HTML>
```

The key aspects of code in Table 3 are:
Line 2 and 3 show a message that is displayed to the user while login data is being sent to serverABC 305. The message indicates to the user that the login credentials are being passed to the remote server 305. This is the only text visible to the user. All other data is hidden.
Line 4 is the start of a hidden form. The action element of the form is set to the URL at serverABC that processes login requests.
Line 5 is the input element for userID at serverABC. It is hidden.
Line 6 is the input element for user's password at serverABC. It too is hidden.

Line 8 creates an inline flame on the same page. The source of this page is another HTML file, serverAbcLogin.html on the smart card. The code for this file is shown in Table 4. The code of Table 4 contains the JavaScript code to fill the username and password data and to automatically submit the form to serverABC.

TABLE 4
Script to cause the filled in form to be transmitted to the remote
server 305.

```
1  <SCRIPT LANGUAGE=“JavaScript”>
2  function setValue( ) {
3  parent.document.loginForm.userID.value =
      “myUserID”;
4  parent.document.loginForm.userPassword.value =
      “myUserPassword”;
5  parent.document.loginForm.submit( );
6  }
7  </SCRIPT>
8  <BODY OnLoad=“setValue( )”>
9  </BODY>
```

The key aspects of code in Listing 3 are:
Line 1 starts a JavaScript code section, and line 7 ends it.
Line 3 sets the value of username.
Line 4 sets the value of user password.
Line 5 submits the form to serverABC, 305.
Line 8 indicates that the function setValue( ) should be called as soon as this frame is loaded. This allows the login data to be submitted automatically.

The JavaScript code from serverAbcLogin.html is automatically launched, step 415 by the execution of line 8 Table 4. The confidential user login credential data is kept on the smart card 307 and placed in serverAbcLogin.html file before being sent to the browser B2 313.

The second web browser B2 313 sends the form data containing user login information to the URL at the remote server (serverABC) 305 that processes login requests. This URL is specified in line 4 of the code of Table 3.

When the remote server (serverABC) 305 authenticates the user, the user is granted access to the remote server 305.

This example described herein above describes the use of HTML and JavaScript code to pass user login data to a merchant server. The embodiment illustrated by the example reuses the same browser instance B2 313 through which session cookies have been stored. This browser reuse is possible through the TARGET element of HREF tag. In an alternative embodiment, browser window handles are used. The connection link 505 that goes to the login page of serverABC 305 creates a new web browser window B2 313. The handle of this window is saved inside the JavaScript code. The link that goes to serverAbc.html on smart card web server 309 reuses this window handle.

In an alternative embodiment, the user would only be required to click on one link to cause the execution of the two logical process steps: connecting to a login page on remote server 305; and having the login credentials transmitted from the smart card 307 to the remote server 305. In such an embodiment, the services page transmitted from the NSC web server 309 contains a link to “connect and login to” for each remote server supported by the NSC 307. Clicking on one such link first triggers the connection to the corresponding remote server 305 and then a subsequent login request message is automatically sent to the smart card web server 309, without any additional action from the user. Sending of the second message—the login request to smart card web server 309—is delayed until the login page from remote server 305 is loaded and all cookies have been written to the local host computer 301.

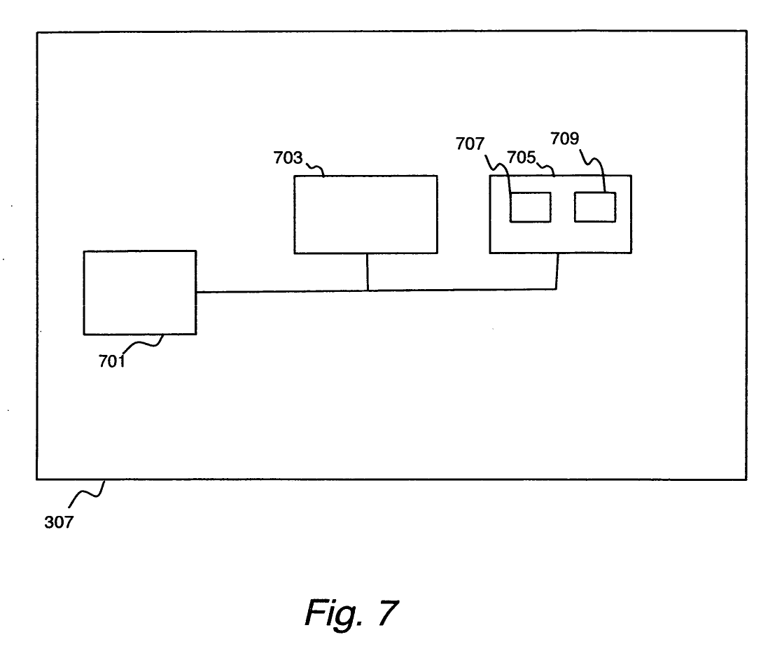

FIG. 7 is a block diagram illustrating one possible hardware architecture for the secure storage device 307. The secure storage device 307 is, for example, a network smart card. Typically a network smart card 307 has a communications interface 701 by which the network smart card 307 may be connected to a smart card reader or other interface unit for communication with a host computer. The communications interface 701 may be, for example, a contact pad having electrical contacts for making electrical connections to a smart card reader. Alternatively, the communications interface 701 is a means for wireless communication.

The network smart card 307 further includes a processor 703 connected to the communications means and to a memory 705. For illustrative purposes, the memory 705 is illustrated as one unit. In practice, the memory 705 would usually be divided into several distinct memory areas, e.g., a read-only memory, a random access memory, a programmable read-only memory.

The memory 705 contains one or more application programs 707 having instructions to direct the processor 703 to receive and send data to other computers, e.g., the host computer 301 or the remote server 306.

The memory 705 further contains one or more data stores 709 for storing data, e.g., login credentials for a user.

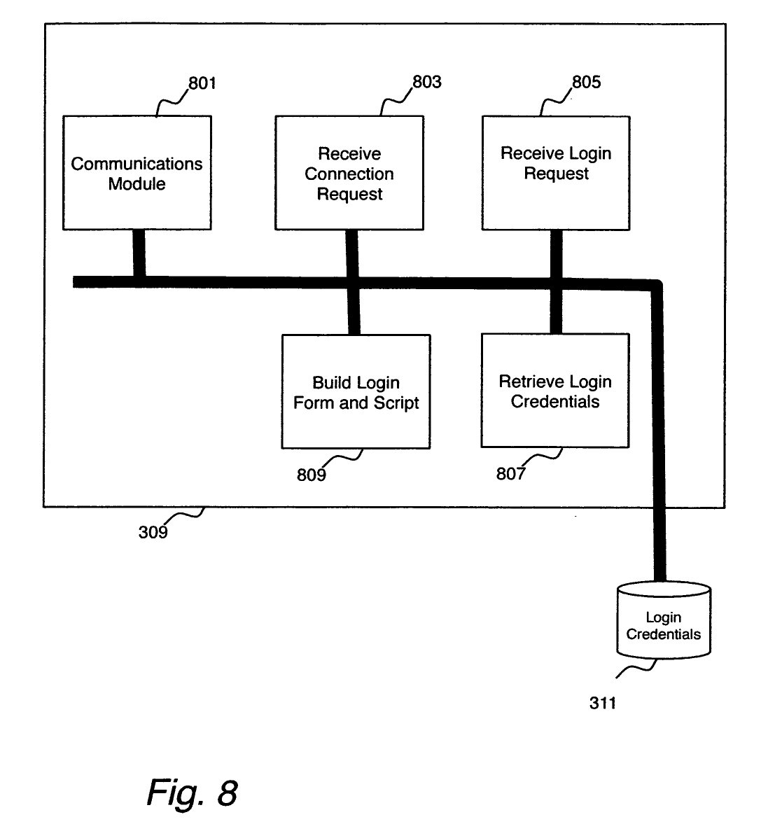

FIG. 8 is a block diagram illustrating several software modules of one embodiment of smart card web server 309 according to the invention. The web server 309 contains a communications module 801 to enable the smart card 307 to communicate in a secure fashion to remote computers over a network. Such a communication module 801 is described in greater detail in co-pending patent application Ser. No. 10/848,738. The communications module 801 is connected to several other modules: a receive connection request module 803, a receive login request module 805, a retrieve login credentials module 807, and a build login form and script module 809.

The receive connection request module 803 contains software logic to direct the communications module in establishing a communications channel between the smart card 307 and the local host computer 301. Thus, the connection request module 803 contains smart card side logic to implement the step to establish a connection, message traffic 402 of FIG. 4. Furthermore, the connection request received as part of the message traffic 402 represents a user's request to use the smart card 307 to login to a remote server. Thus, the receive connection request module 803 further contains logic to retrieve a list of supported remote servers from the login credentials database 311. Finally, the receive connection request module 803 further contains logic that, upon having retrieved the list of supported remote servers, builds the web page containing the list of supported services, e.g., as shown as web page 501, and logic to direct the communications module 801 to transmit that web page to the requesting web browser instance on the local host computer 301.

The web server 309 further contains a software module 805 to receive a login request message 412. The login request message 412 contains an indication of which server to which the user wishes to connect. The receive login request module 805 would then call on the retrieve login credentials module 807 to retrieve the login credentials for the server from the login credentials database 311 and any other information necessary to produce a login form, e.g., the form illustrated in Table 3. This additional information includes the tags used by the particular remote server for username and password. These tags are inserted by the build login form and script module 809 into a template for the login form together with the user's username and password.

The build login form and script module 809 further contains logic to build the login script, e.g., as shown in Table 4.

The receive login request module 805 further contains logic to call upon the communications module 801 to transmit the login form and login script to the indicated browser instance on the local host computer 301.

From the foregoing it will be appreciated that method and system for secure login of the present invention provides an efficient and secure method of having login credentials stored and supplied by a secure network storage device, e.g., a network smart card, without requiring any modifications to either the local host computer being used by a user trying to log in to a remote server or that remote server. Furthermore, the actual values of the login credentials are never exposed. This technique addresses an existing need that is not served by prior art form-fill software approaches because this new technique provides a more portable way of passing login data from any machine. The user is not restricted to the machine on which form-fill software is installed. In addition the user is protected from potential phishing attacks.

This use of the network smart card allows secure logins without any changes to the existing merchant servers.

While the present invention has been described hereinabove in the context of automatic provision of login credentials from a network smart card to a remote server, the invention may also be used to provide other information that may be required by a remote server. Examples of such information include, but are not limited to account numbers, addresses, social security numbers, telephone numbers, identification numbers, biographical information (e.g., height, weight, race, blood type, known allergies). The modifications needed to the above described techniques include providing in the smart card the tags used by the remote server for such information and the corresponding user data.

To provide for such use of the above-described technique, the services page 501 may include an additional link to provide user data. The network smart card webserver would then also contain code to provide such data in a form For example, if the remote server is used for online shopping, the server may request a shipping address having the tags “Street Address”, “City”, “State”, “ZIPCODE”.

Although specific embodiments of the invention have been described and illustrated, the invention is not to be limited to the specific forms or arrangements of parts so described and illustrated. The invention is limited only by the claims.

We claim:

1. A method for secure authentication to a remote server, comprising:
a) establishing a connection between a host computer used by a user and a token having stored thereon login credentials for the user;
b) transmitting from the token to the host computer a server list containing a list of servers available for secure authentication using the token;
c) using the list to establish a connection from the host to the remote server;
d) receiving on the host computer a login page from the remote server;
e) transmitting a login command from the host computer to the token directing the token to provide login credentials to the remote server;
f) in response to receiving the login command, transmitting the login credentials and login software module from the token to the host computer; and
g) executing the login software module on the host computer to fill in the login page and to cause the transmission of the filled-in login page from the host computer to the remote sever.

2. The method of secure authentication to a remote server of claim 1 wherein the server list is a web page containing a connect-to-server link and a login link for each server available for secure authentication using the token.

3. The method of secure authentication to a remote server of claim 1 further comprising storing on the token a database having stored therein the login information necessary for at least one server to which the token may present login credentials.

4. The method of secure authentication to a remote server of claim 3 wherein the login command from the host computer to the token contains an indicator of which server to log in to; the method further comprising:
in response to receiving the login command from the host computer retrieving the login information from the database having stored therein the login information to which the token may present login credentials.

5. The method of secure authentication to a remote server of claim 1 further comprising starting a first browser window (B1) and using the first browser window (B1) to execute the establishing a connection between the host computer and the token, and opening a second browser window to display the login page from the remote server.

6. The method of secure authentication to a remote server of claim 1 wherein the login software is a JavaScript operable to provide the remote server with the login credentials in a form expected by the remote server.

7. The method of secure authentication to a remote server of claim 1 wherein the token is a smart card.

8. A method of operating a smart card to present login credentials to a remote server on behalf of a user, comprising:
storing on the smart card the login credentials for at least one remote server;
receiving a connection request from a host computer transmitted to the smart card from a first web browser window;
transmitting from the smart card to the first web browser window a list of remote servers to which the smart card may present login credentials in the form of a web page having thereon a connection link to establish a connection to the remote server and a login link to log in to the remote server, wherein the execution of the connection link operates to open the response from the remote server in a second web browser window;
receiving from the first web browser window a login request to direct the smart card to present the login credentials of the user to the remote server via the second web browser window; and
upon receipt of the request to present the login credentials, transmitting from the smart card the login credentials of the user and a login software module to the second web browser window, wherein the software module is operable to automatically transmit the login credentials to the remote server.

9. The method of operating a smart card to present login credentials of claim 8 further comprises storing with the login credentials for a remote server any information expected by the remote server with the login credentials.

10. The method of operating a smart card to present login credentials of claim 9 wherein the information expected by the remote server includes a username tag, a password tag, a username, and a password.

11. A secure storage device for providing login credentials to a remote server via a host computer, comprising:
a processor;
a memory connected to the processor;
a communications interface connected to the processor;
a communications module operable to cause the processor to communicate via the communications interface to a host computer and via a network to remote computers;
a store for storing login credentials for at least one service operating on a remote server;
logic to cause the processor to receive a request from the host computer to establishing a connection between the host computer and the storage device having stored thereon login credentials for the user;
logic to cause the processor to transmit from the secure storage device to the host computer a server list containing a list of servers available for secure authentication using the secure storage device;
logic to cause the processor to receive a login command from the host computer directing the secure storage device to provide login credentials to the remote server; and
logic to cause the processor, in response to receiving the login command, to transmit the login credentials and a login software module from the secure storage device to the host computer wherein the login software module contains logic to cause the host computer to fill in a login page from the remote server and to cause the transmission of the filled-in login page from the host computer to the remote sever.

12. The secure storage device of claim 11 wherein the server list is a web page containing a connect-to-server link and a login link for each server available for secure authentication using the token.

13. The secure storage device of claim 11 comprising logic to cause the processor to transmit the web page containing a connect-to-server link and login link to a first web browser instance on the host computer and the connect-to-server link is operable to cause the host computer to open a second browser window to display the login page from the remote server.

14. The secure storage device of claim 11 further wherein the store for storing login credentials is a database having stored therein the login information necessary for at least one server to which the secure storage device may present login credentials.

15. The secure storage device of claim 11 wherein the login command from the host computer to the secure storage device contains an indicator of which server to log in to, the secure storage device further comprising:
logic operable, in response to receiving the login command from the host computer, to retrieve the login information from the database having stored therein the login information to which the token may present login credentials.

16. The secure storage device of claim 11 further comprising logic to cause the processor to transmit the web page containing a link to request the secure storage device to transmit information required by the remote server and stored on the secure storage device.

17. The secure storage device of claim 11 wherein the login software is a JavaScript operable to provide the remote server with the login credentials in a form expected by the remote server.

18. The method of secure authentication to a remote server of claim 11 wherein the secure storage device is a smart card.
